(19) United States
(12) Patent Application Publication
(10) Pub. No.: US 2023/0000259 A1
(43) Pub. Date: Jan. 5, 2023

(54) SPEAKER RECEPTACLE FOR A BED RAIL

(71) Applicant: James Rodney Taylor, Franklin, TN (US)

(72) Inventor: James Rodney Taylor, Franklin, TN (US)

(21) Appl. No.: 17/367,555

(22) Filed: Jul. 5, 2021

(51) Int. Cl. A47C 21/00; H04R 1/02

(52) U.S. Cl. CPC A47C 21/003; H04R 1/026

(57) ABSTRACT

A speaker receptacle, including a main body to receive at least one item therein, a plurality of protruding edges disposed on at least one of a first edge and a second edge of the main body opposite with respect to the first edge, each of the plurality of protruding edges to protrude away from the first edge and the second edge of the main body, and a rail fastener disposed on at least a portion of the main body to detachably connect the main body to a bed rail.

### BACKGROUND

### 1. Field

The present general inventive concept relates generally to a receptacle, and particularly, to a speaker receptacle for a bed rail.

### 2. Description of the Related Art

Hospital pillow speakers are useful entertainment and communication devices for patients during a stay at a hospital. Moreover, the hospital pillow speaker is found in virtually all hospital settings as they often enable patients to access a nurse call button, the television, sound systems, lights, and/or various other devices within a hospital room.

Unfortunately, the pillow speakers have a high tendency of falling under a hospital bed, on a floor, and/or between a bed rail during use, which requires the patient to either physically move to retrieve the pillow speakers and/or to call someone for assistance. For some patients, movement can be painful and/or impossible.

Therefore, there is a need for a speaker receptacle for a bed rail that prevents the pillow speaker from falling off the bed.

### SUMMARY

The present general inventive concept provides a speaker receptacle for a bed rail.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a speaker receptacle, including a main body to receive at least one item therein, a plurality of protruding edges disposed on at least one of a first edge and a second edge of the main body opposite with respect to the first edge, each of the plurality of protruding edges to protrude away from the first edge and the second edge of the main body, and a rail fastener disposed on at least a portion of the main body to detachably connect the main body to a bed rail.

The main body may include a front surface concavely disposed on a first side of the main body, and a second surface convexly disposed on a second side of the main body opposite with respect to the first side.

The front surface may adhesively connect to the at least one item therein.

Each of the plurality of protruding edges may be disposed at a distance away from the first end of the main body.

The rail fastener may include a plurality of fastener receiving apertures disposed on at least a portion of the main body, and a strap fastener removably connected through each of the plurality of fastener receiving apertures to connect each end of the strap fastener.

The speaker receptacle may further include a cord receiving groove disposed on at least a portion of a second end of the main body to receive a cord of the at least one item therethrough.

### BRIEF DESCRIPTION OF THE DRAWINGS

These and/or other features and utilities of the present generally inventive concept will become apparent and more readily appreciated from the following description of the embodiments, taken in conjunction with the accompanying drawings of which:

FIG. 1A illustrates a front perspective view of a speaker receptacle for a bed rail, according to an exemplary embodiment of the present general inventive concept;

FIG. 1B illustrates a rear perspective view of the speaker receptacle for the bed rail, according to an exemplary embodiment of the present general inventive concept;

FIG. 2A illustrates a front perspective view of a speaker receptacle for a bed rail, according to another exemplary embodiment of the present general inventive concept;

FIG. 2B illustrates a rear perspective view of the speaker receptacle for the bed rail, according to another exemplary embodiment of the present general inventive concept;

FIG. 3A illustrates a front perspective view of a speaker receptacle for a bed rail, according to another exemplary embodiment of the present general inventive concept; and

FIG. 3B illustrates a rear perspective view of the speaker receptacle for the bed rail, according to another exemplary embodiment of the present general inventive concept.

### DETAILED DESCRIPTION

Various example embodiments (a.k.a., exemplary embodiments) will now be described more fully with reference to the accompanying drawings in which some example embodiments are illustrated. In the figures, the thicknesses of lines, layers and/or regions may be exaggerated for clarity.

Accordingly, while example embodiments are capable of various modifications and alternative forms, embodiments thereof are shown by way of example in the figures and will herein be described in detail. It should be understood, however, that there is no intent to limit example embodiments to the particular forms disclosed, but on the contrary, example embodiments are to cover all modifications, equivalents, and alternatives falling within the scope of the disclosure. Like numbers refer to like/similar elements throughout the detailed description.

It is understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.).

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements and/or components, but do not preclude the presence or addition of one or more other features, integers, steps, operations, elements, components and/or groups thereof.

Unless otherwise defined, all terms (including technical and scientific terms) used herein have the same meaning as commonly understood by one of ordinary skill in the art to which example embodiments belong. It will be further understood that terms, e.g., those defined in commonly used dictionaries, should be interpreted as having a meaning that is consistent with their meaning in the context of the relevant art. However, should the present disclosure give a specific meaning to a term deviating from a meaning commonly understood by one of ordinary skill, this meaning is to be taken into account in the specific context this definition is given herein.

### LIST OF COMPONENTS

Speaker Receptacle 100

Main Body 110

Front Surface 111

Rear Surface 112

Protruding Edges 120

Rail Fastener 130

Cord Receiving Groove 140

Speaker Receptacle 200

Main Body 210

Front Surface 211

Rear Surface 212

Protruding Edges 220

Rail Fastener 230

Cord Receiving Groove 240

Speaker Receptacle 300

Main Body 310

Front Surface 311

Rear Surface 312

Protruding Edges 320

Rail Fastener 330

Fastener Receiving Apertures 331

Strap Fastener 332

Cord Receiving Groove 340

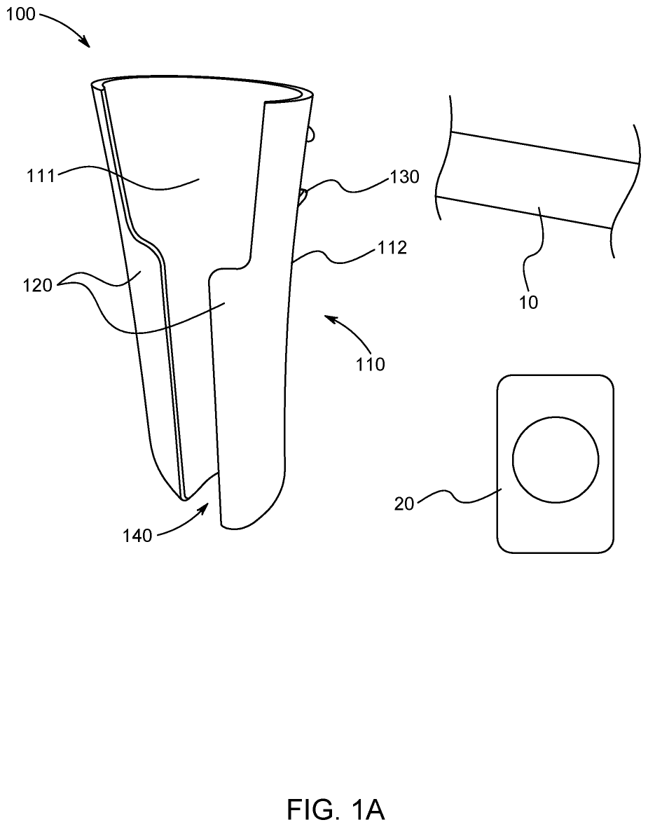

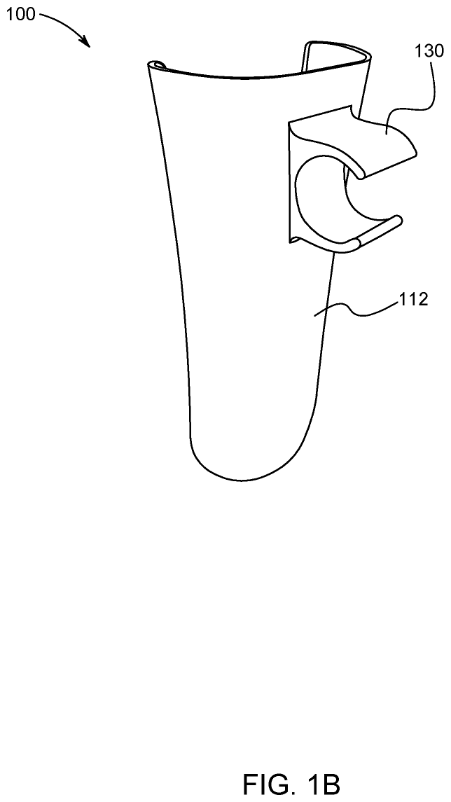

FIG. 1A illustrates a front perspective view of a speaker receptacle 100 for a bed rail 10, according to an exemplary embodiment of the present general inventive concept.

FIG. 1B illustrates a rear perspective view of the speaker receptacle 100 for the bed rail 10, according to an exemplary embodiment of the present general inventive concept.

The speaker receptacle 100 may be constructed from at least one of metal, plastic, wood, ceramic, glass, and rubber, etc., but is not limited thereto. Also, the speaker receptacle 100 may be constructed of recycled materials.

The speaker receptacle 100 may include a main body 110, a plurality of protruding edges 120, a rail fastener 130, and a cord receiving groove 140, but is not limited thereto.

Referring to FIGS. 1A and 1B, the main body 110 is illustrated to have an open cylindrical shape. However, the main body 110 may be rectangular, circular, conical, triangular, pentagonal, hexagonal, heptagonal, octagonal, or any other shape known to one of ordinary skill in the art, but is not limited thereto.

The main body 110 may include a front surface 111 and a rear surface 112, but is not limited thereto.

The front surface 111 (a.k.a., a first surface) may be concavely disposed on at least a portion of a first side of the main body 110. In other words, the front surface 111 may be concave, such that the front surface 111 curves in a “C” shape with respect to a view from the first end and/or the second end of the main body 110.

Additionally, the front surface 111 may have an adhesive (e.g., tape, glue) disposed on at least a portion thereof to adhesively receive and/or connect to at least one item 20 therein. For example, the front surface 111 may adhesively receive a pillow speaker 20 therein, such that the front surface 111 may resist removal of the pillow speaker therefrom. However, the front surface 111 may receive the at least one item 20, such as a television remote, a mobile device, a cell phone, a tablet computer, and/or any other device.

The rear surface 112 (a.k.a., a second surface) may be convexly disposed on at least a portion of a second side of the main body 110 opposite with respect to the first side. In other words, the rear surface 112 may be convex, such that the rear surface 112 curves in a “C” shape with respect to a view from the first end and/or the second end of the main body 110.

Also, the main body 110 may taper from a first end toward a second end opposite with respect to the first end, such that a circumference and/or a diameter of the main body 110 at the first end is greater than a circumference and/or a diameter of the main body 110 at the second end. As such, the main body 110 may provide a snug fit of the pillow speaker 20 therein.

The plurality of protruding edges 120 may be constructed of similar material to the main body 110. Alternatively, the plurality of protruding edges 120 may be constructed of a silicone polymer that retains its shape while undisturbed, and at least partially deform (i.e., bend, stretch) in response to an application of force thereto. In other words, the plurality of protruding edges 120 may be flexible, and move and/or have a different position and/or shape in response to the application of force by a user.

Referring again to FIG. 1A, the plurality of protruding edges 120 may be disposed on a first edge and/or a second edge of the main body 110 opposite with respect to the first edge, such that the first edge and/or the second edge curve toward a center between the first edge and/or the second edge. Moreover, each of the plurality of protruding edges 120 may protrude away from the first edge and/or the second edge of the main body 110 at a distance away from the first end and/or the second end of the main body 110. Additionally, each of the plurality of protruding edges 120 may be disposed a distance away from each other, such that the plurality of protruding edges 120 may not contact each other. As such, the plurality of protruding edges 120 may form an “L” shape along the first edge and/or the second edge of the main body 110.

Furthermore, the plurality of protruding edges 120 may facilitate extraction of the pillow speaker 20 from within the main body 110 due to the position of each of the plurality of protruding edges 120 and the “L” shape.

Referring to FIG. 1B, the rail fastener 130 is illustrated to be a clip. However, the rail fastener 130 may be a nail, a screw, a washer, a nut, a bolt, a rope, a string, a wire, a magnet, and/or any combination thereof, but is not limited thereto.

The rail fastener 130 may be disposed on at least a portion of the rear surface 112. The rail fastener 130 may detachably connect the main body 110 to the bed rail 10. As such, the rail fastener 130 may prevent the main body 110 from falling from the bed rail 10. Accordingly, the main body 110 may be suspended from the bed rail 10 via the rail fastener 130.

The cord receiving groove 140 may be disposed on at least a portion of the second end of the main body 110. Moreover, the cord receiving groove 140 may be disposed between each of the plurality of protruding edges 120. The cord receiving groove 140 may receive a cord of the at least one item therethrough. For example, the cord receiving groove 140 may receive a power cord of the pillow speaker 20 therethrough.

Therefore, the speaker receptacle 100 may be detachably connected to the bed rail 10, such that a patient has easy access to the pillow speaker 20. The speaker receptacle 100 may be disposable to prevent contamination of use between patients. Also, the speaker receptacle 100 may prevent the pillow speaker 20 from falling on a floor and/or between a mattress of a bed. As such, the speaker receptacle 100 may ensure the patient does not lose the pillow speaker 20.

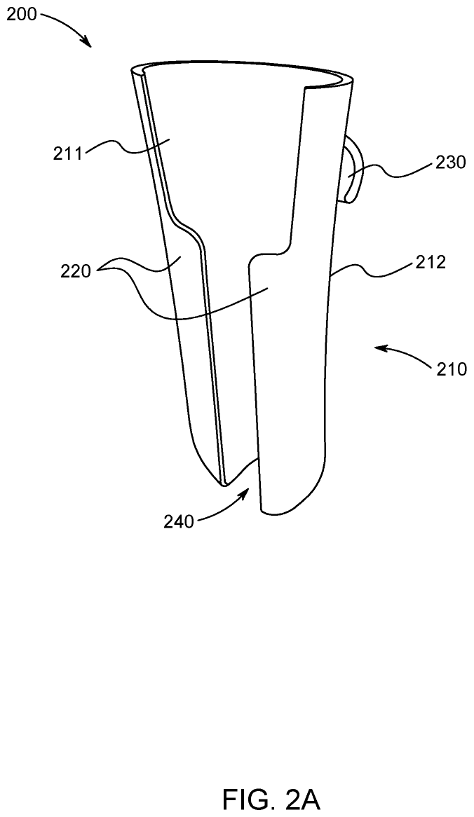

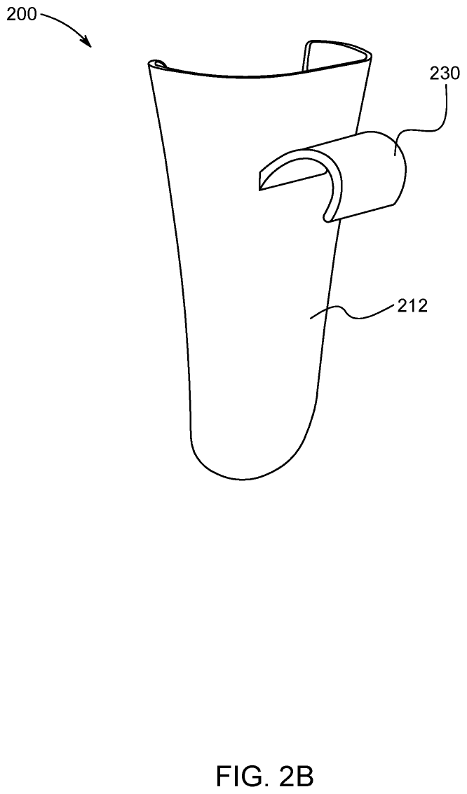

FIG. 2A illustrates a front perspective view of a speaker receptacle 200 for a bed rail 10, according to another exemplary embodiment of the present general inventive concept.

FIG. 2B illustrates a rear perspective view of the speaker receptacle 200 for the bed rail 10, according to another exemplary embodiment of the present general inventive concept.

The speaker receptacle 200 may be constructed from at least one of metal, plastic, wood, ceramic, glass, and rubber, etc., but is not limited thereto. Also, the speaker receptacle 200 may be constructed of recycled materials.

The speaker receptacle 200 may include a main body 210, a plurality of protruding edges 220, a rail fastener 230, and a cord receiving groove 240, but is not limited thereto.

Referring to FIGS. 2A and 2B, the main body 210 is illustrated to have an open cylindrical shape. However, the main body 210 may be rectangular, circular, conical, triangular, pentagonal, hexagonal, heptagonal, octagonal, or any other shape known to one of ordinary skill in the art, but is not limited thereto.

The main body 210 may include a front surface 211 and a rear surface 212, but is not limited thereto.

The front surface 211 (a.k.a., a first surface) may be concavely disposed on at least a portion of a first side of the main body 210. In other words, the front surface 211 may be concave, such that the front surface 211 curves in a “C” shape with respect to a view from the first end and/or the second end of the main body 210.

Additionally, the front surface 211 may have an adhesive (e.g., tape, glue) disposed on at least a portion thereof to adhesively receive and/or connect to at least one item 20 therein. For example, the front surface 211 may adhesively receive a pillow speaker 20 therein, such that the front surface 211 may resist removal of the pillow speaker therefrom. However, the front surface 211 may receive the at least one item 20, such as a television remote, a mobile device, a cell phone, a tablet computer, and/or any other device.

The rear surface 212 (a.k.a., a second surface) may be convexly disposed on at least a portion of a second side of the main body 210 opposite with respect to the first side. In other words, the rear surface 212 may be convex, such that the rear surface 212 curves in a “C” shape with respect to a view from the first end and/or the second end of the main body 210.

Also, the main body 210 may taper from a first end toward a second end opposite with respect to the first end, such that a circumference and/or a diameter of the main body 210 at the first end is greater than a circumference and/or a diameter of the main body 210 at the second end. As such, the main body 210 may provide a snug fit of the pillow speaker 20 therein.

The plurality of protruding edges 220 may be constructed of similar material to the main body 210. Alternatively, the plurality of protruding edges 220 may be constructed of a silicone polymer that retains its shape while undisturbed, and at least partially deform (i.e., bend, stretch) in response to an application of force thereto. In other words, the plurality of protruding edges 220 may be flexible, and move and/or have a different position and/or shape in response to the application of force by a user.

Referring again to FIG. 2A, the plurality of protruding edges 220 may be disposed on a first edge and/or a second edge of the main body 210 opposite with respect to the first edge. Moreover, each of the plurality of protruding edges 220 may protrude away from the first edge and/or the second edge of the main body 210 at a distance away from the first end and/or the second end of the main body 210. Additionally, each of the plurality of protruding edges 220 may be disposed a distance away from each other, such that the plurality of protruding edges 220 may not contact each other. As such, the plurality of protruding edges 220 may form an “L” shape along the first edge and/or the second edge of the main body 210.

Furthermore, the plurality of protruding edges 220 may facilitate extraction of the pillow speaker 20 from within the main body 210 due to the position of each of the plurality of protruding edges 220 and the “L” shape.

Referring to FIG. 2B, the rail fastener 230 is illustrated to be a clip. However, the rail fastener 230 may be a nail, a screw, a washer, a nut, a bolt, a rope, a string, a wire, a magnet, and/or any combination thereof, but is not limited thereto.

The rail fastener 230 may be disposed on at least a portion of the rear surface 212. The rail fastener 230 may detachably connect the main body 210 to the bed rail 10. As such, the rail fastener 230 may prevent the main body 210 from falling from the bed rail 10. Accordingly, the main body 210 may be suspended from the bed rail 10 via the rail fastener 230.

The cord receiving groove 240 may be disposed on at least a portion of the second end of the main body 210. Moreover, the cord receiving groove 240 may be disposed between each of the plurality of protruding edges 220. The cord receiving groove 240 may receive a cord of the at least one item therethrough. For example, the cord receiving groove 240 may receive a power cord of the pillow speaker 20 therethrough.

Therefore, the speaker receptacle 200 may be detachably connected to the bed rail 10, such that a patient has easy access to the pillow speaker 20. The speaker receptacle 200 may be disposable to prevent contamination of use between patients. Also, the speaker receptacle 200 may prevent the pillow speaker 20 from falling on a floor and/or between a mattress of a bed. As such, the speaker receptacle 200 may ensure the patient does not lose the pillow speaker 20.

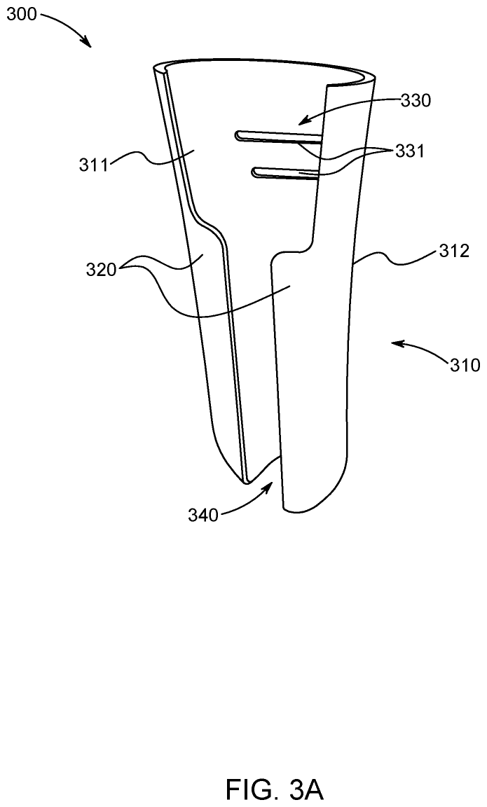

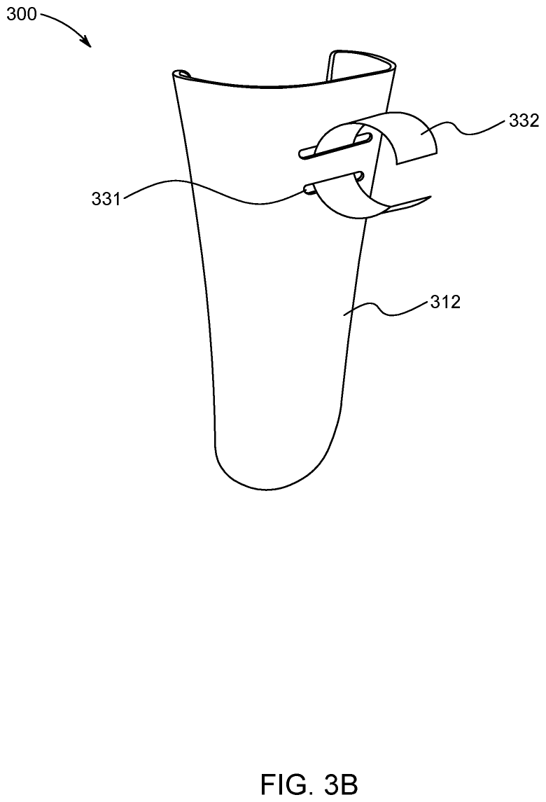

FIG. 3A illustrates a front perspective view of a speaker receptacle 300 for a bed rail 10, according to another exemplary embodiment of the present general inventive concept.

FIG. 3B illustrates a rear perspective view of the speaker receptacle 300 for the bed rail 10, according to another exemplary embodiment of the present general inventive concept.

The speaker receptacle 300 may be constructed from at least one of metal, plastic, wood, ceramic, glass, and rubber, etc., but is not limited thereto. Also, the speaker receptacle 300 may be constructed of recycled materials.

The speaker receptacle 300 may include a main body 310, a plurality of protruding edges 320, a rail fastener 330, and a cord receiving groove 340, but is not limited thereto.

Referring to FIGS. 3A and 3B, the main body 310 is illustrated to have an open cylindrical shape. However, the main body 310 may be rectangular, circular, conical, triangular, pentagonal, hexagonal, heptagonal, octagonal, or any other shape known to one of ordinary skill in the art, but is not limited thereto.

The main body 310 may include a front surface 311 and a rear surface 312, but is not limited thereto.

The front surface 311 (a.k.a., a first surface) may be concavely disposed on at least a portion of a first side of the main body 310. In other words, the front surface 311 may be concave, such that the front surface 311 curves in a “C” shape with respect to a view from the first end and/or the second end of the main body 310.

Additionally, the front surface 311 may have an adhesive (e.g., tape, glue) disposed on at least a portion thereof to adhesively receive and/or connect to at least one item 20 therein. For example, the front surface 311 may adhesively receive a pillow speaker 20 therein, such that the front surface 311 may resist removal of the pillow speaker therefrom. However, the front surface 311 may receive the at least one item 20, such as a television remote, a mobile device, a cell phone, a tablet computer, and/or any other device.

The rear surface 312 (a.k.a., a second surface) may be convexly disposed on at least a portion of a second side of the main body 310 opposite with respect to the first side. In other words, the rear surface 312 may be convex, such that the rear surface 312 curves in a “C” shape with respect to a view from the first end and/or the second end of the main body 310.

Also, the main body 310 may taper from a first end toward a second end opposite with respect to the first end, such that a circumference and/or a diameter of the main body 310 at the first end is greater than a circumference and/or a diameter of the main body 310 at the second end. As such, the main body 310 may provide a snug fit of the pillow speaker 20 therein.

The plurality of protruding edges 320 may be constructed of similar material to the main body 310. Alternatively, the plurality of protruding edges 320 may be constructed of a silicone polymer that retains its shape while undisturbed, and at least partially deform (i.e., bend, stretch) in response to an application of force thereto. In other words, the plurality of protruding edges 320 may be flexible, and move and/or have a different position and/or shape in response to the application of force by a user.

Referring again to FIG. 3A, the plurality of protruding edges 320 may be disposed on a first edge and/or a second edge of the main body 310 opposite with respect to the first edge. Moreover, each of the plurality of protruding edges 320 may protrude away from the first edge and/or the second edge of the main body 310 at a distance away from the first end and/or the second end of the main body 310. Additionally, each of the plurality of protruding edges 320 may be disposed a distance away from each other, such that the plurality of protruding edges 320 may not contact each other. As such, the plurality of protruding edges 320 may form an “L” shape along the first edge and/or the second edge of the main body 310.

Furthermore, the plurality of protruding edges 320 may facilitate extraction of the pillow speaker 20 from within the main body 310 due to the position of each of the plurality of protruding edges 320 and the “L” shape.

Referring again to FIGS. 3A and 3B, the rail fastener 330 may include a plurality of fastener receiving apertures 331 and a strap fastener 332 (e.g., a cord, a string, a rope, a wire, a hook and loop fastener), but is not limited thereto.

The plurality of fastener receiving apertures 331 may be disposed on at least a portion of the rear surface 312, such that each of the plurality of fastener receiving apertures 331 may be distanced from each other. The strap fastener 332 may removably connect through each of the plurality of fastener receiving apertures 331, such that the strap fastener 332 may connect each end thereof and form a loop. As such, the strap fastener 332 may prevent the main body 310 from falling from the bed rail 10. Accordingly, the main body 310 may be suspended from the bed rail 10 via the rail fastener 330.

The cord receiving groove 340 may be disposed on at least a portion of the second end of the main body 310. Moreover, the cord receiving groove 340 may be disposed between each of the plurality of protruding edges 320. The cord receiving groove 340 may receive a cord of the at least one item therethrough. For example, the cord receiving groove 340 may receive a power cord of the pillow speaker 20 therethrough.

Therefore, the speaker receptacle 300 may be detachably connected to the bed rail 10, such that a patient has easy access to the pillow speaker 20. The speaker receptacle 300 may be disposable to prevent contamination of use between patients. Also, the speaker receptacle 300 may prevent the pillow speaker 20 from falling on a floor and/or between a mattress of a bed. As such, the speaker receptacle 300 may ensure the patient does not lose the pillow speaker 20.

The present general inventive concept may include a speaker receptacle 100, including a main body 110 to receive at least one item 20 therein, a plurality of protruding edges 120 disposed on at least one of a first edge and a second edge of the main body 110 opposite with respect to the first edge, each of the plurality of protruding edges 120 to protrude away from the first edge and the second edge of the main body 110, and a rail fastener 130 disposed on at least a portion of the main body 110 to detachably connect the main body 110 to a bed rail 10.

The main body 110 may include a front surface 111 concavely disposed on a first side of the main body 110, and a second surface 112 convexly disposed on a second side of the main body 110 opposite with respect to the first side.

The front surface 111 may adhesively connect to the at least one item 20 therein.

Each of the plurality of protruding edges 120 may be disposed at a distance away from the first end of the main body 110.

The rail fastener 330 may include a plurality of fastener receiving apertures 331 disposed on at least a portion of the main body 310, and a strap fastener 332 removably connected through each of the plurality of fastener receiving apertures 331 to connect each end of the strap fastener 332.

The speaker receptacle 100 may further include a cord receiving groove 140 disposed on at least a portion of a second end of the main body 110 to receive a cord of the at least one item 20 therethrough.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A speaker receptacle, comprising:
a main body to receive at least one item therein;
a plurality of protruding edges disposed on at least one of a first edge and a second edge of the main body opposite with respect to the first edge, each of the plurality of protruding edges to protrude away from the first edge and the second edge of the main body; and
a rail fastener disposed on at least a portion of the main body to detachably connect the main body to a bed rail.

2. The speaker receptacle of claim 1, wherein the main body comprises:
a front surface concavely disposed on a first side of the main body; and
a second surface convexly disposed on a second side of the main body opposite with respect to the first side.

3. The speaker receptacle of claim 2, wherein the front surface adhesively connects to the at least one item therein.

4. The speaker receptacle of claim 1, wherein each of the plurality of protruding edges is disposed at a distance away from the first end of the main body.

5. The speaker receptacle of claim 1, wherein the rail fastener comprises:
a plurality of fastener receiving apertures disposed on at least a portion of the main body; and
a strap fastener removably connected through each of the plurality of fastener receiving apertures to connect each end of the strap fastener.

6. The speaker receptacle of claim 1, further comprising:
a cord receiving groove disposed on at least a portion of a second end of the main body to receive a cord of the at least one item therethrough.
